(19) United States
(12) Patent Application Publication
(10) Pub. No.: US 2025/0053940 A1
(43) Pub. Date: Feb. 13, 2025

(54) Same Screen Uninterrupted Gesture Based Transaction: A Method and System for Initiating a Financial Transaction Process

(71) Applicant: Oscar Hauptman, Chon Buri (TH)

(72) Inventor: Oscar Hauptman, Chon Buri (TH)

(21) Appl. No.: 18/799,369

(22) Filed: Aug. 9, 2024

Related U.S. Application Data
(60) Provisional application No. 63/531,748, filed on Aug. 9, 2023.

(51) Int. Cl. G06Q 20/10; G06F 3/04883; G06Q 20/40

(52) U.S. Cl. CPC G06Q 20/10; G06F 3/04883; G06Q 20/407

(57) ABSTRACT

A method and system for initiating an on-line financial transaction, being applied, to pledges, donations, and the overall payments marketplace. This System operates on Technology Platforms and Social Networks, without interfering with the user's consumption of digital content displayed on a device's screen. A financial transaction is triggered through a simple user Gesture such as tapping on a smart device screen displaying the content. The System processes a financial transaction, without requesting the user to define the amount or the beneficiary or confirm any details—providing an uninterrupted financial transaction, while keeping the user on the same screen and enabling an uninterrupted content consumption

### CROSS-REFERENCE TO RELATED APPLICATIONS

This application claims priority under 35 U.S.C. § 119 (e) to U.S. Provisional Patent No. 63/531,748 filed on Aug. 9, 2023.

### TECHNICAL FIELD

The present invention relates to on-line financial transactions, including, as non-limiting examples, pledges, donations, and payments.

### BACKGROUND

Users spend substantial amounts of time engaging with digital content on Technology Platforms and Social Networks. User engagement mostly relates to viewing or interacting with (i.e., consuming) content created by another user or influencer. Users who consume content have limited means of expressing appreciation to the content creators. They can express a “like” gesture via a button or a tap on specific content, or they can “follow” the influencer via a button. Some platforms have experimented with a “tip” gesture button, but its execution and user engagement and experience is markedly different. Even though user engagement with these tip gestures continues to increase, they focus on generating revenue (e.g. advertising) for the platform and content creators, therefore limiting the potential value of these interactions.

In addition, typical transaction processes interrupt the user's consumption of content, and prompt the user for more information (e.g. amount, quantity, date, recipient, payment method, etc.) and to confirm/approve the information, before proceeding forward with the transaction. The payment process takes the user away from the content on the screen. Even with quick-pay buttons, and similar solutions, the button appears on the screen over the content being consumed, and when the quick-pay button is clicked or tapped, the button requests an authorization/identification (e.g. password or pin), displays processing of payment and finally a confirmation notice is provided on the button. Throughout this process there are several elements that interfere with content consumption on the screen, taking the user's attention away from content to provide password or similar information or confirmation.

The System provides a more effective way for users to engage with and consume content and process financial transactions (or otherwise) without the disadvantages discussed above.

This System provides the user with the ability to convey a gesture of appreciation of the content created by Content Creators by donating to a single charitable cause (without limiting). This elevates user engagement from a superficial like/follow Gesture, to a “donate” Gesture providing real world financial impact. This interaction provides both the Content Creator and the Content Consumer with an enhanced level of engagement beyond simple entertainment value by establishing financial contributions that have real physical impact for the betterment of society (without limiting). To illustrate the System's aggregate impact of micro-donations ($0.01), Social Networks collectively generate an estimated 100 trillion ‘Likes’ annually-a simple 1% conversion of “Likes” engagement into Gestures can potentially generate $10 billion in annual donations to a single global cause. Such scale of impact and worldwide accessible participation, necessitates that the single charitable cause (i) have universal support across the global community, and (ii) be scalable to deploy multi-billion dollars in donations per year. Furthermore, by limiting the Gesture beneficiary to a single charitable cause, (a) simplifies and accelerates the decision for the System participants (i.e. an uninterrupted decision process), (b) enhances societal impact of the System and (c) increases the probability of viral adoption of the System by Social Networks users.

The System provides the user with the ability to consume content on the device's screen and trigger a financial transaction, (i.e. pledge/donation) or a non-financial process, with a simple user Gesture without leaving the screen, literally providing an uninterrupted content consumption experience. The Gesture can be customized to include various finger taps, swipes, or even voice commands to initiate the transaction. The System has zero footprint on the device or the viewed content-no button is clicked for this financial transaction and the user's consumption/viewing of the content continues uninterrupted.

Furthermore, the System enables the user to initiate a financial transaction without providing specific information or confirmation of the transaction. The user is not asked to fill a form, nor provide any additional information, such as amount, quantity, date, recipient of the payment, etc. —which would otherwise slow down the transaction process (or potentially rendering the transaction incomplete-any delay or pause, or request in payment processing, increases the chance the User gets distracted and does not complete the transaction). The System provides an uninterrupted financial transaction (UFT), where the System executes the financial transaction without requiring further user input—the user is not prompted for additional information, selection or to confirm the transaction, the transaction process does not pause subject to user confirmation or information. The System recognizes the content on the device and uses a pre-defined logic or predictive systems such as artificially intelligence to automatically determine the specifications for the transactions without prompting user for additional information or selection or decision. By removing the need for any user information/confirmation (beyond the Gesture), the System enables a rapid, frictionless and uninterrupted transaction—an Uninterrupted Financial Transaction (UFT).

Users are typically sensitive regarding financial transactions, and therefore, they tend to be resistant to such transactions or trigger additional decision-making processes that disrupt the transaction process. The System reduces this resistance by (a) making the transaction experience seamless and integrated with content consumption, (b) using micropayments of $0.01 (without limiting) minimizes the risk associated with the transaction and ensures accessible participation by all Users, and (c) by limiting the beneficiaries of the transaction to charities, as opposed to a merchant or an individual person, (d) by setting a single charity as the beneficiary of transactions, simplifies the charity selection process (ie pre-selected charity) and encourages rapid participation from the global community. (e) by having non-binding pledge commitments (optional) reduces resistance associated with formal binding financial commitment, (f) by providing charitable donation tax benefits (if available, optional) reduces the cost of participation, (g) and removing any decision-making processes (beyond the Gesture) that can cause friction with the transaction process (i.e. no additional information, selection or confirmation is requested from the user). Once users become accustomed to this easy and seamless transaction experience, the System can be modified to accommodate the broader payments marketplace (without limiting).

This System does not interfere with content consumption, nor does it force the user to move away from the content screen. As a non-limiting example, only a small coin animation briefly appears on the content screen as a notification of the donation. As a further non-limiting example, the “donate” Gesture consists of a 2-finger double tap, which is similar to a 1-finger single tap gesture used for a “like,” which is the most widely used gesture in social media. This System leverages on existing user familiarity or habit for a “like”, to significantly accelerate user adoption of the donation Gesture.

This System is designed to reduce the user's resistance to financial engagement by, without limiting, shifting the user's perception of the transaction from profit based to charity based. The user is encouraged to support the content creator by financially engaging with a charity on behalf of the content creator-ascribing credit to the Content Creator for inspiring the donation or the origination of the donation. The System may also makes the financial engagement non-binding by a “pledge”, which further reduces the user's resistance to the financial engagement. Furthermore, the System can limit the monetary amount of the financial engagement to as little as $0.01 per Gesture so that the individual financial engagement is inconsequential to the user, thereby further reducing user resistance and providing accessible participation. In addition, the System may also utilize a tax efficient structure, that enables the users to receive a tax benefits in the form of charitable donation receipts. In another non-limiting example, the System uses a weekly subscription model for payments to further reduce resistance by encouraging small weekly (or monthly) payments to charities. The System provides a method for users to financially engage with the relevant charity for an extended time period (e.g., 1 year) without leaving the screen. The arrangement (initial setup) for settling the financial transaction is required only at one time (e.g., during this 1-year period), and thereafter, payments will be processed automatically. On a weekly (or monthly) basis, the users' pledged transactions will be consolidated and settled by the user through a payment transaction made to the charity.

### Additional Applications and Optional Modules:

### Multi-Charity, DAF Application.

The System can be adapted to have multiple charities as beneficiaries. One such multi-charity application is where Gesture initiated transaction is made to a Donor Advised Fund (DAF), administered by a registered non-profit DAF Sponsor, utilizing the platform's inherent pay mechanism. On a yearly basis, the DAF Sponsor will issue charitable tax receipts to the users after disbursing funds to the designated charities or the charities selected by the content creator.

A DAF structure typically provides its service independently, where donors (users) select from a list of charities to which they designate distribution to charities. For DAF Application, the System integrates DAF structure within a Technology Platform or Social Network, such that the charity selection process is integrated with the user's content consumption experience (unlike traditional checklist selection). The System provides a same-screen, Gesture-based (i) donation amount and (ii) the charity selection for the DAF structure—this represents another embodiment of the Systems use of Gestures on displayed content, that results in a decision/selection by the user or triggers a process, without interrupting the user's content consumption nor the financial transaction.

The System also provides content creators the ability to support their favorite charitable cause, without making a specific monetary request within their content, or diverting the user experience away from the content. In addition, the System can display the cumulative amount of money raised for charity by each digital content. This brings a new dimension of user engagement and satisfaction—providing users and content creators direct real-time feedback on the charitable impact of each digital content. As a non-limiting example, when a user performs the Gesture (e.g. double tap), for a brief moment coins and the cumulative amount raised for charity appears on the displayed content. In this example, the user is incentivized to perform the Gesture in order to access specific information—i.e. cumulative amount raised for charity by the digital content.

### Gifting or Tipping Application.

The System can be adapted for gifting or tipping application, where the content creator or site owner is provided the payment, as opposed to a charity. The System provides shall incorporate artificial intelligence and other tools so ensure no additional information or confirmation is requested (i.e. no decision, information required beyond the Gesture)—providing an uninterrupted transaction. Even the amount of the tip or gift can be customized in terms of (without limiting): (1) per user and (2) per content creator-based on artificial intelligence and analytical systems that analyze past history of transactions, social media profile, spending habits, time of year, ceremonial days, anniversaries, birthdays, any public/private information, etc. The System also enables uninterrupted consumption of content, where the visual que a “Like” (a small heart appearing on top of the content for a short-time) is similarly replaced with an appropriate image of a tip or gift. History of tipping or gifting will also be available for record keeping. The System provides the ability to quickly gift or tip, without interruption (frictionless), while providing the ability to cancel/reverse gift/tip (where applicable). Furthermore, using Systems device (phone) based fingerprinting system, a user can autonomously tip/gift for an extended period of time (eg pledged stored in device), until settlement occurs (requiring identification).

### Payment Application.

The System can be adapted for broadly for payments application. As an example, a patent owned by MasterCard International (U.S. Pat. No. 9,495,699 B2. Method and System for Purchasing of Goods and Services Via Image Recognition), presents a solution for making transactions easier, faster, and more efficient for customers, e-commerce transactions conducted via internet. This MasterCard solution incorporates image-based recognition of the product being sold online, searching the availability of the product and related price-presenting on the screen of the buyer's device, a form (or similar) that includes an image of the product, merchant identifier having availability, number of product desired, and method of payment for processing. The buyer is requested to confirm the information/selection before the transaction is processed. This process interrupts both the content displayed on the screen and interrupts the transaction by prompting the buyer to confirm additional information (e.g. price, merchant identified, and quantity, etc.).

The solution presented the System uses, without limiting, pre-set constraints/limits and artificial intelligence to the transaction process is uninterrupted. No further request for information or confirmation. No decision is requested beyond the Gesture. All necessary information, pre-authorization, constraints, limits are all set in advance, etc. The Gesture (in case of screen gesture) determined what product on the screen is intended to be purchased. Product search online and price suitability is determined by artificial intelligence and any pre-defined parameters (eg past purchasing habits, online profile, credit worthiness, residential address, expenditure patterns, shipping preferences, shipping cost sensitivity, etc). Each Gesture is set to 1 quantity (measure of quantity also determined by AI systems). Payment confirmation and payment methods are predetermined or settled periodically separated from the transaction initiation (Gesture). Additional security and identification systems that operate without interfering the transaction can be used to for buyer identification or confirmation (e.g. System's finger printing solution). Furthermore, content on the screen is not interrupted-a payment notification is provided by image of the product (together with purchase price) appear at a small overlay on the screen for a brief instance at location on screen where the Gesture was triggered (similar to the “like” image on social networks). In effect, upon the triggering the Gesture, the transaction process completes without further decision-making friction (i.e. uninterrupted transaction) and without distracting the buyer from the screen (i.e. uninterrupted content consumption). The buyer can be provided the option to cancel transaction (as predictive AI improves transaction cancellation/reversal risk would be further reduced). The affect of this System on commerce volumes would be analogous to the effect on commerce volumes when merchants provided 90 day post-purchase returns—the fact the buyer can return in 90 days, helps the buyer to complete an online purchase decision faster and less likely to result in incomplete transaction process.

### Module-Gesture Intensity (Optional).

Existing social media Gestures are linear in form, meaning the “like” is selected or unselected based on one tap triggering the element on or off—a binary outcome. With this new System, the pledge/donate Gesture is non-linear in form and is unbounded, which means the more the user triggers the Gesture, the more the user pledges/donates. In fact, repeated Gestures at a given time, geometrically increases the pledges/donation. This System allows the user to appreciate content with differing intensity. As a non-limiting example, the more satisfying the content, the more the user can donate. While one Gesture equates to a $0.01 pledge, multiple Gestures separated by a specific interval of time allow each instance of the Gesture to correspond to an additional $0.01 pledge. When multiple Gestures are initiated successively without a break, each successive Gesture, or sets of Gestures, increase the pledged amount geometrically (e.g., three Gestures in quick succession equate to a $0.05 pledge, five Gestures in quick succession equate to a $0.20 pledge). Artificial intelligence will be employed to further modulate the donation for a Gesture or given set of successive Gestures based on a variety of variables which include, without limiting user's profile, history of multiple Gestures, history of content viewed or engagement, social media presence, device used (and its cost), socio-economic factors, geographical location, credit worthiness, etc. If the user has a history of triggering Gestures to specific content creators, future successive Gestures will result in a higher pledged amount. For example, successive Gestures can result in a $0.20 pledge for general content, and a $0.50 pledge for content that is frequently appreciated by the user.

Furthermore, the user's relative intensity of appreciation in the System is not limited to a scale of 1 to 10 or similar construct. Not only is the appreciation unbounded and unlimited, but the triggering of successive Gestures is uniquely customized for each user based on their history of Gestures, social media presence, socio-economic factors, geography, credit worthiness, etc.

Module—Blockchain (optional).

The System also utilizes blockchain ledger technology, a decentralized, distributed, and public digital ledger that is used to record transactions across many computers so that the record cannot be altered retroactively without the alteration of all subsequent blocks and the consensus of the network. The transactional data (pledge, donations, etc.) is also recorded in a blockchain, which provides greater trust and transparency to all participants. The System also incorporates software tools that allow each user to decode their transactional history from the blockchain. In addition, the System incorporates other tools and mechanisms that enhance the integrity of the System.

### Certain Definitions and Notes

“Technology Platform”, defined as the software that supports basic computer functions, such as operating systems released by Apple Inc. (e.g., iOS, OS X, etc.), Google Inc. (e.g., Android), Microsoft Corporation (e.g., Windows, Windows Mobile), etc.

“Social Networks”, defined herein as social media platforms (e.g., Instagram, TikTok, Twitter, etc.), social networks, or any application on a Technology Platform (e.g., an application on a smartphone device).

“Content Creator”, defined as users of Technology Platform or Social Network that creates content on such platforms. Also includes influencers on Social Networks.

“Content Consumer”, defined as users of Technology Platform or Social Network that views, consumes or interacts with content created by Content Creator.

“User”, defined as a user of Technology Platform and/or Social Network.

DAF Sponsor, such as Silicon Valley Community Fund.

“Gesture”, defined an action or trigger by a User on device with a Technology Platform or Social Network, that initiates the transaction (or selection) on the System (e.g. donation or pledge). Such a gesture can be a double 2-finger tap by the User on such device. The Gesture can be customized, such as including various finger taps, swipes, or even voice commands to initiate the transaction.

The “Tip” gesture has been used by some social media platforms, which provides content consumers the ability to financially reward the content creators, but it is of 1 denomination (i.e. click button for either tip a fixed amount) (the donation system is not limited), and Tip gesture is devoid of the positive satisfaction generated by charitable donations.

After the Gesture, there may be some limited UI feedback or notification that does not disrupt content consumption.

In DAF application, where neither content user nor creator has identified the charity, the System allocates to charities based on system-wide historical average.

Credit worthiness assessment can be done through a variety of sources, formal and non-formal, 3rd party and/or internal sources.

DAF Sponsor, such as Silicon Valley Community Fund.

Without limiting, the amount raised for charity for a digital content can be displayed the same way the count of ‘likes’ is displayed on some Social Networks.

After the transaction is accepted or completed, the user can have the options of cancelling such transactions.

See link for white paper on enhancing integrity of the System: http://q-r.to/beEN75

### SUMMARY

In accordance with one aspect of the disclosure, a method of performing an on-line financial transaction is disclosed, the method comprises: receiving a financial transaction request from a user, wherein such request is received from a Gesture on the same screen displaying digital content on Technology Platform or Social Network; receiving information about the amount of the transaction from the Gesture or predefined by the method; receiving information about the beneficiary from the user (content consumer) or content creator, content, Gesture, or predefined by the method; utilizing predefined variables and/or predictive tools, including artificial intelligence, to determine all information required to complete the transactions, without any additional user prompt for information, selection or confirmation; processing the financial transaction request based on the information; and notifying the user of the transaction notification on the screen without interfering with the user's consumption of the digital content on the device.

In accordance with another aspect of the disclosure, a system of performing an on-line financial transaction is disclosed. The system comprises: receiving a financial transaction request from a user, wherein such request is received from a Gesture on the same screen displaying digital content on Technology Platform or Social Network; receiving information about the amount of the transaction from the Gesture or predefined by the system; receiving information about the beneficiary from the user (content consumer) or content creator, content, Gesture, or predefined by the system; utilizing predefined variables and/or predictive tools, including artificial intelligence, to determine all information required to complete the transactions, without any additional user prompt for information, selection or confirmation; processing the financial transaction request based on the information; and notifying the user of the transaction notification on the screen without interfering with the user's consumption of the digital content on the device.

In accordance with another aspect of the disclosure, a non-transitory computer readable medium having stored thereon machine-readable instructions executable to cause a machine to perform operations, comprising: receiving a transaction request from a user, wherein such request is received from a Gesture on the same screen displaying digital content on Technology Platform or Social Network; receiving information about the amount of the; receiving information about the amount of the transaction from the Gesture, or predefined by the system and method; receiving information about the beneficiary charity from the Gesture and the content displayed, or predefined by the system and method; utilizing predefined variables and/or predictive tools, including artificial intelligence, to determine and store all information required to complete the transactions, without any additional user prompt for information, selection or confirmation; processing the financial transaction request based on the information; notifying the user of the transaction with a small disappearing notification on the screen without interfering with the user's consumption of the digital content on the device; and receiving the donations, allocating and distributing donations to charities; and adding to the user satisfaction from engaging with social media platforms.

These and other aspects and features of the present disclosure will be better understood upon reading the following detailed description when read in conjunction with the accompanying drawings.

### BRIEF DESCRIPTION OF THE DRAWINGS

FIG. 1 is a flowchart showing the process for making a pledge according to one embodiment.

FIG. 2 shows stages of the user-performed action through the pledging process according to one embodiment.

FIG. 3 is a flow diagram of a routine that enables automated settlement of pledges.

FIG. 4 is a flow diagram of a routine to make possible interoperability with various systems.

FIG. 5 is a block diagram representing an embodiment of the present invention.

FIG. 6 is a flow diagram showing the process for providing payment details for future settlement of pledges.

FIG. 7 is a flow diagram showing the process of notifying Donor Advisor Funds (DAFs) by scanning publicly available data recorded by the present invention on a blockchain system.

The figures depict one embodiment of the presented invention for purposes of illustration only. One skilled in the art will readily recognize from the following discussion that alternative embodiments of the structures and methods illustrated herein may be employed without departing from the principles described herein.

### DETAILED DESCRIPTION

A method and system for initiating an on-line financial transaction, being applied, without limiting, to pledges, donations, and the overall payments marketplace (the “System”). This System operates on Technology Platforms and Social Networks. The System's application is not limited to financial transactions but can be applied to any decision or selection made by the participants or any other non-financial application.

Without interfering with the user's consumption of digital content, as displayed on a device's screen, a financial transaction is triggered through a simple user Gesture, such as tapping on a smart device's screen displaying the content. The System processes a financial transaction, without requesting the user to define the amount or beneficiary or confirm such details. The user's Gesture, or series of Gestures on the System defines the beneficiary and amount for the financial transaction while keeping the user on the same screen and enabling the user to consume (view) content on the device's screen.

For the Systems donation application, the user pledges an amount to the charities selected by the user or content creators on any digital platform. On a weekly basis, the users' pledged transactions will be consolidated and settled by the user through a payment transaction made to a Donor Advised Fund (DAF), administered by a registered non-profit DAF Sponsor. On a yearly basis, the DAF Sponsor will issue charitable tax receipts to the users after disbursing funds to the designated charities. The System also provides a new method of integrating DAF services seamlessly with the user's content consumption on Social Network and Technology Platforms, i.e., the same screen Gesture provides (i) donation amount and (ii) charity selection for the DAF structure. Blockchain technology is utilized to record transactional data, providing greater trust and transparency to all participants. The System facilitates rapid adoption and diffusion of the invention by simultaneously combining several aspects including: (a) a simple user Gesture of appreciation that is distinct, yet similar to the existing “like” gesture on social media; (2) non-binding pledge commitments; (3) acceptance of microtransaction amounts (e.g. $0.01); (4) charitable donation tax benefits from a DAF structure.

The System's combination of these processes provides a new way of interacting with and consuming content on Social Network or Technology Platforms and provides users (content consumers) an engaging experience and association with charitable giving. However, the System is not limited to charitable financial transactions. In another embodiment, the System can be used for broader payment processing services.

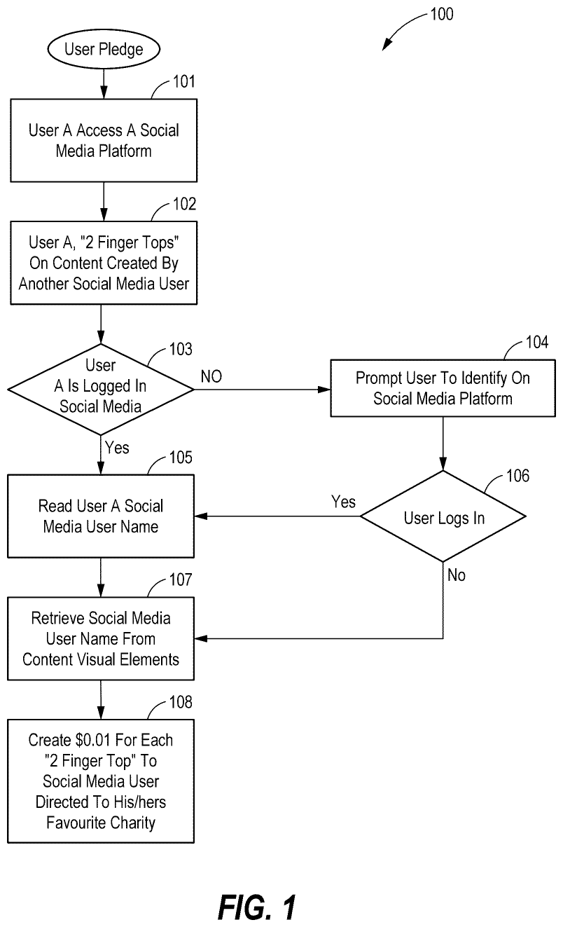

FIG. 1—In step 101, User initiates the pledge by accessing any Social Network that contains the System installed. When browsing through the content, in step 102, the user performs a two-finger tap anywhere inside the defined visual boundaries of a particular content. In step 103, if User A is logged in, the host application triggers the pledge action providing the main means of identification of User A. Each two-finger tap will generate a pledge of 0.01 USD. In step 104, if the user is not logged in, it is prompted to do so. In step 105, if a user logs in, the performed pledge is stored along with relevant data of the host application. In step 107, if the user does not log in, only the relevant content creator's data is saved along with the pledge parameters. In either option, the flow can still proceed towards step 108.

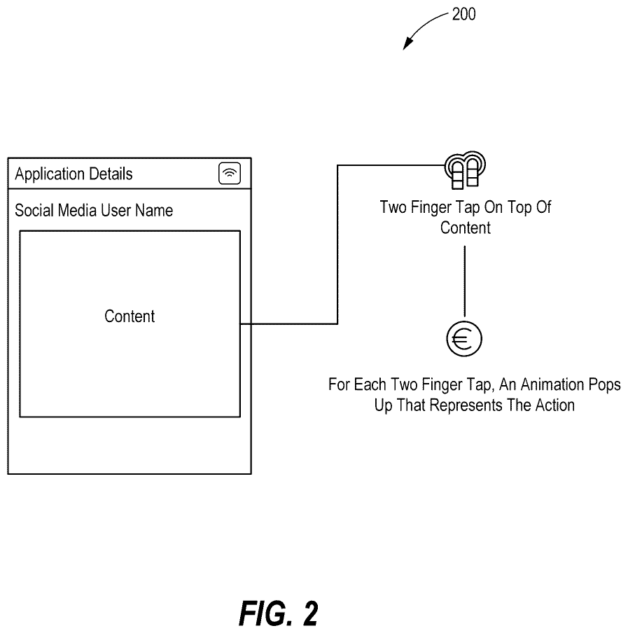

FIG. 2—Illustrates a payment initiator in one embodiment of the present invention. It is illustrated how such action could happen when integrated with a host application. By performing the single action, the whole process of the invention is triggered. An animation is displayed that functions as feedback for the user that such action was performed.

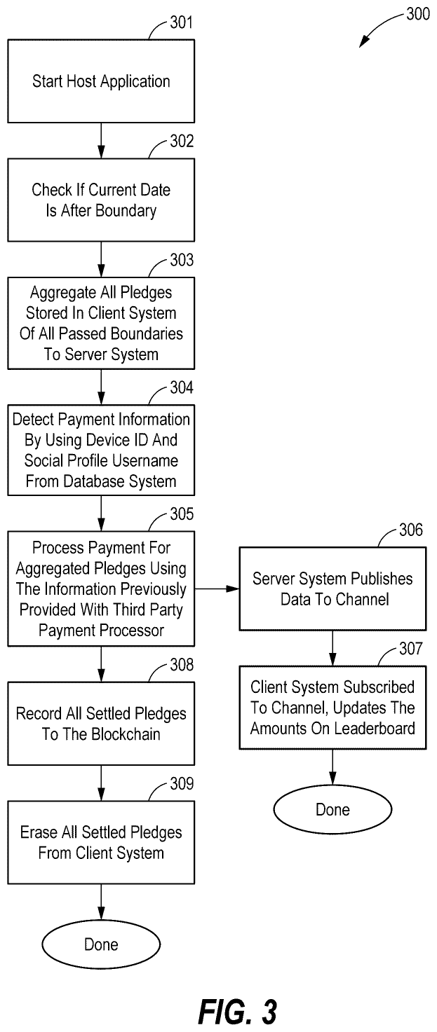

FIG. 3—is a flow diagram of a routine that enables automated settlement of pledges without the need of further user interaction. In step 301, the host application is bootstrap on a mobile device. After application initiates, in step 302, a start-up routine executes and checks if the current date (according to the operating system of device) is after the set 1-week boundary defined to settle pledges into donations. In step 303, all pledges stored on an in-memory database that satisfy such prerequisites are aggregated into a single payload to be sent to the server system along with user's identifying data such as but not limited to social profile, username, and device's unique generated ID. In step 304, the server system maps the received data to previously provided payment details. In step 305, this payment is processed with the third-party payment processing provider. After a successful charge on the aggregated amount of the pledges, in step 306 the server system publishes the processed data to a channel in an event bus mechanism. Another component of the server system receives the message of the event bus at 307 and updates the leaderboard database with the new relevant data, calculating the proper score for each received pledge. Any client system subscribed to the same bus may receive the updated data and update the interface accordingly. At step 308, all settled pledge data is recorded to the blockchain system only with publicly available data appended to the aggregated data of step 304. All data stored related to pledges on the in-memory database are erased at step 309.

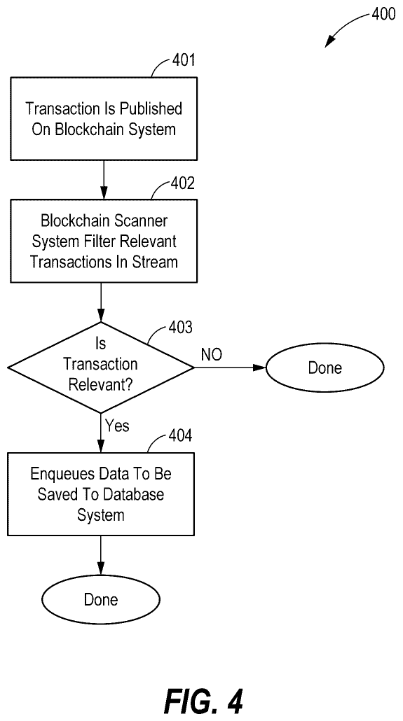

FIG. 4—is a flow diagram of a routine that enables interoperability between any interested party's system to have access to publicly available data that is stored to the blockchain. After all transactions related to the settlement of pledges are sent to the blockchain at step 401, a blockchain scanner system filters any transaction on the stream of data that is relevant to the present invention at step 402. After processing the stream of transactions, if no relevant metadata is found the system ends the processing and waits for more transactions to be published. At step 404, the relevant data is sent to a queue system to be stored to the database system.

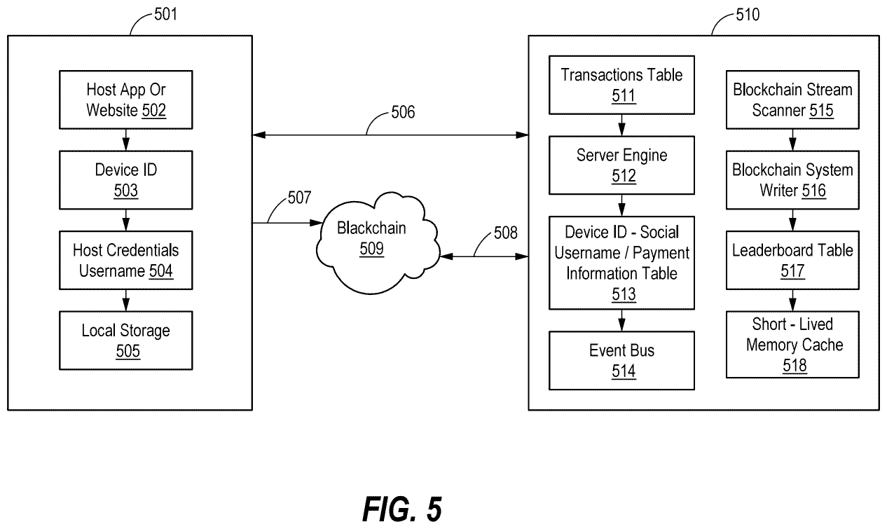

FIG. 5—is a block diagram of a networked system used in an on-line payment flow according to an embodiment of the invention. Client system 501 includes a client mobile device that is capable of running applications or websites 502, a server system 510, a blockchain system of any kind 509.

Client device 501 and server system 510 may each include one or more processors, memories, and other appropriate components for executing instructions such as program, code and/or data stored on one or more computer readable mediums to implement the various applications, data, and steps described herein.

The client system 501 is capable of generating a unique device ID 503 through code and storing any type of data including the means of identification of host app 504 in local storage 505. Such devices should also be able to access the world wide web (WWW) through any means.

Network 506, 507 and 508 may be implemented as a single network or a combination of multiple networks. For example, in various embodiments, network 506 may include the Internet or one or more intranets, landline networks, wireless networks and/or other appropriate types of networks. Network 507 may communicate via the Internet through any appropriate protocol or be excluded in favor of network 507 and 508 to feed data into blockchain system 509.

Server engine 511 may be used to process and intermediate any type of communication between various components of the system via appropriate type of network.

The present invention employs a blockchain system 509 for secure storage of relevant data. The blockchain system is utilized to record, verify, and timestamp pledge transactions ensuring immutability and transparency in the donation settlement process.

Blockchain system writer 514 may communicate to the blockchain system via any kind of protocol suitable for its implementation and preprocess data relevant to the pledge definition. In certain embodiments of the system, the blockchain system writer may be excluded and this responsibility may be delegated to the client system.

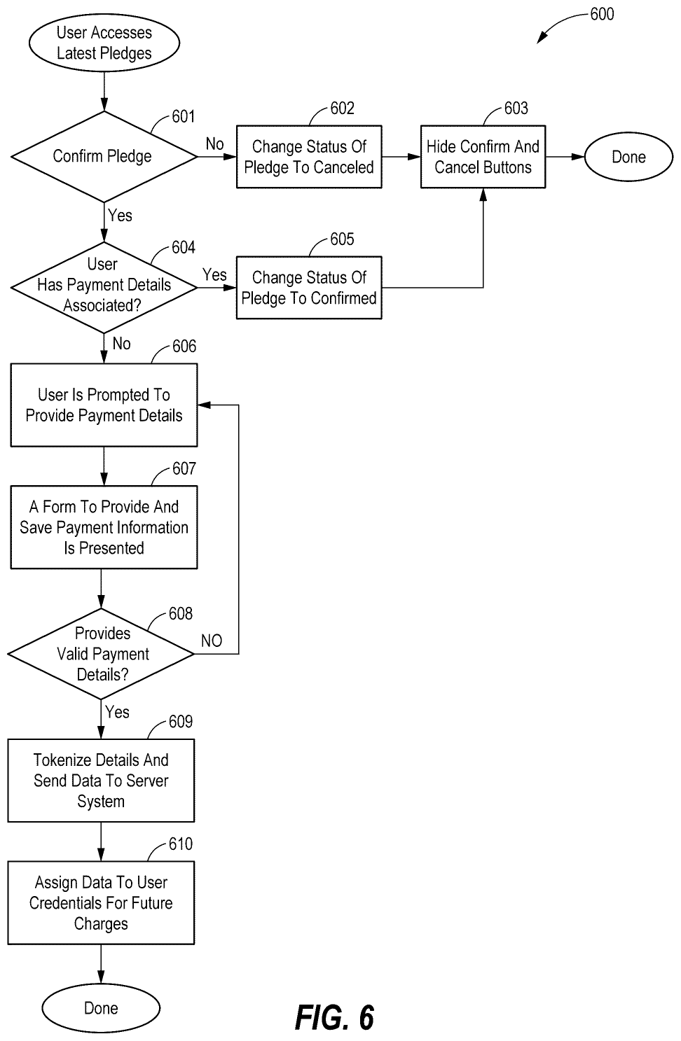

FIG. 6—By accessing latest pledges performed and selecting a pledge, the user is presented with the option of confirming or canceling a pledge 601. By selecting cancel, the pledge stored changes status to canceled and will not be considered when settlement is due 602. By selecting confirm, the client system sends a verification request for available payment methods assigned to the user 604. In a positive case 605, the status of the pledge is changed to confirmed and the buttons of confirm and cancel are hidden 603 to state that no more action is needed regarding that particular pledge. In a negative case, the user is prompted to provide payment details 606 and a web form is presented to that end 607. The payment details are then verified with the third-party payment processor system 608. In case the provided details are valid 609, the information is tokenized and sent to the server system and assigned to the requesting user for future usage 610.

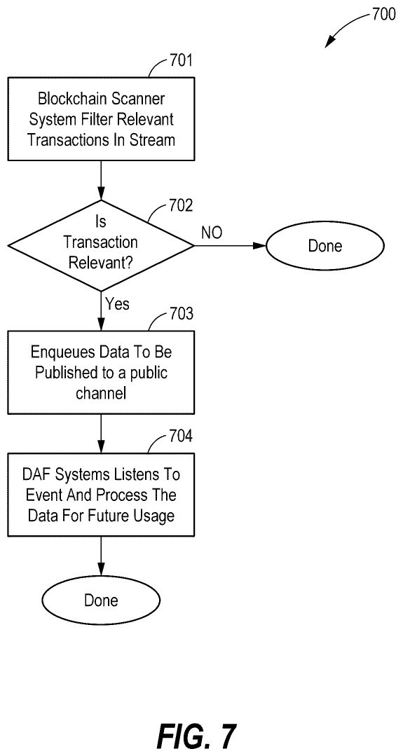

FIG. 7—At the end of the defined time frame, the blockchain scanner system scans the transaction stream of that period 701 for recorded transactions signed with a public-private key pair configured to the present invention 702. In a positive case, the data is then processed and enqueued to publish the data into a public channel 703. Any DAF system connected to the event bus may then process and store the data for future usage 704.

### INDUSTRIAL APPLICABILITY

The method of performing an on-line financial transaction as described in the present disclosure has wide-ranging industrial applicability across multiple digital platforms and social networks. This technology can be seamlessly integrated into various content consumption platforms, including video streaming services, social media networks, news websites, and other digital content platforms where user engagement and transactions are crucial. By enabling transactions directly from the screen displaying digital content, the method enhances user experience and streamlines the process of supporting content creators and making purchases.

Video Streaming Services: In video streaming services, users can donate to content creators or make purchases while watching videos without leaving the video player. For instance, during a live stream, users can perform a gesture, such as a two-finger tap on the screen, to send tips or purchase merchandise directly from the content creator. This not only supports the content creators but also keeps the viewers engaged without interrupting their viewing experience.

Social Media Networks: The technology can be employed in social media platforms to enable users to support their favorite influencers or causes effortlessly. By integrating the financial transaction system within the social media app, users can make donations or payments by performing simple gestures like tapping or shaking their device. This reduces the friction associated with traditional payment methods and encourages more frequent contributions.

News Websites: For news websites, this method allows readers to contribute to investigative journalism or subscribe to premium content with minimal disruption. As readers engage with articles, they can make quick gestures to trigger financial transactions, such as donations or subscriptions, supporting the publication's efforts. This streamlined process ensures that readers remain immersed in the content while also providing financial support.

The implementation of single-action gestures (e.g., tapping, voice commands, device shaking) significantly simplifies the transaction process, making it intuitive and accessible. This ease of use reduces the cognitive load on users, encouraging more frequent and spontaneous transactions. For example, a user watching a live stream can quickly tap the screen to send a tip, enhancing their interaction with the content and providing immediate support to the creator.

Non-disruptive notifications are another key enhancement. By providing transaction notifications on the same screen without interrupting the content, users remain engaged while being informed of their transaction status. This feature is particularly beneficial in maintaining the flow of content consumption and reducing user frustration. For instance, a confirmation message can appear subtly on the screen after a donation is made, ensuring the user is aware without halting the content.

The method supports both pledge transactions and immediate donations, offering flexibility to users. For example, users can pledge during a content session and have the system consolidate and process these pledges into a donation at a later time, such as weekly or monthly. This flexibility allows users to contribute according to their convenience and financial planning. Moreover, the system can determine the beneficiary based on the content, content consumer, and content creator, ensuring that the funds reach the intended recipient efficiently. This personalized approach enhances the relevance and impact of each transaction.

Content creators benefit significantly from this method as it provides a new revenue stream, encouraging the production of higher quality and more engaging content. The ease of transactions can lead to increased support from viewers, enabling creators to focus on their work without worrying about complicated payment systems. Platform providers also gain advantages from this technology. Digital platforms can see increased user engagement and satisfaction, leading to higher retention rates and potential growth in user base. The added financial transaction capabilities open up new monetization strategies, allowing platforms to share in the revenue generated through transactions.

In practice, users initiate a pledge by accessing a social network with the system installed (Step 101). As they browse content, a two-finger tap within the defined visual boundaries of a particular content triggers the pledge action (Step 102). If the user is logged in, the host application processes the pledge by identifying the user and storing the relevant data (Steps 103-105). If the user is not logged in, the system prompts for login (Step 104), and upon successful login, the pledge is stored along with the necessary data (Step 105). This ensures that both logged-in and non-logged-in users can participate in the pledge process, with the flow proceeding towards further steps (Step 108).

Another embodiment (FIG. 2) illustrates how a single action gesture triggers the entire transaction process within a host application, providing user feedback through animation. This feedback assures the user that their action was successfully registered, enhancing their interaction with the platform.

Automated settlement of pledges is depicted in FIG. 3, where the system consolidates pledges into donations without further user interaction. The host application executes a start-up routine to check if the current date surpasses the set boundary for settling pledges (Step 302). All qualifying pledges are aggregated and sent to the server system for processing (Step 303). The server then maps the received data to the user's payment details and processes the payment (Step 304-305). Successful charges are published to an event bus mechanism, updating the leaderboard database and recording the data to the blockchain system (Steps 306-309).

Moreover, users have the option to confirm or cancel pledges, providing flexibility and control over their transactions (FIG. 6). Selecting cancel changes the pledge status to canceled, while selecting confirm verifies the availability of payment methods and updates the pledge status accordingly (Steps 601-610). This ensures that users retain control over their financial commitments, enhancing trust and reliability in the system.

Access to Transaction History: The system provides users with comprehensive access to their financial transaction history. This history includes the identity of the Technology Platform or Social Network where the user viewed or consumed digital content, the specific digital content on which the transaction was initiated, and the identity of the content creator (Step 402). Users can review their transactions over a period designated by them, including details such as the monetary value of each transaction and the selected charities by both the content consumer and the content creator (Steps 403-404). This transparency ensures users can accurately track their financial contributions and manage their charitable engagements efficiently.

Transactions can be categorized into pledge transactions, donation transactions, or payment transactions (Step 402), offering flexibility in how users choose to support content and causes. Users also have the capability to cancel pledges made during a certain period (Step 602), providing a level of control and flexibility over their financial commitments. The system visually identifies involved parties using their host application's primary identification method (Step 103), making it easier for users to recognize transaction details. Moreover, transaction histories can be shared across all host applications (Step 703) and published on a blockchain (Step 703), ensuring transparency and immutability.

The system includes means for aggregating and reporting transaction data, encompassing total transactions, transaction settlements, pledge transaction distribution, and statistics related to content engagement (Step 304). This aggregated data provides valuable insights into user behavior and content interaction, helping content creators and platform providers optimize their offerings. Furthermore, the system facilitates the display of additional content or enables user interaction within the host application platform (Step 401), enhancing the overall user experience.

Device and Technology Platform Integration: The method utilizes devices configured with antennas to communicate with Technology Platforms, processors to display digital content, memory to store transaction information, and displays to show transaction notifications. These notifications disappear without interfering with the user's content consumption (Step 603), ensuring a seamless experience. Devices can integrate with payment processors, allowing users to perform gestures, which are then identified and stored by the device (Steps 104, 105, and 106). The system utilizes touchscreen or touchpad technology to recognize specific gestures, and the visual boundaries of content are determined based on the content's dimensions and positioning within the user interface (Step 102).

Devices are capable of initiating and completing financial transactions autonomously, operating various applications including social media platforms and browser applications (Step 104). The system employs authentication mechanisms such as social media profile data to identify logged-in users, and device information can be stored with transaction data as part of the identifier information (Steps 103 and 304). This feature ensures that transaction records are comprehensive and reliable, even if the user does not log in during the transaction process. Additionally, the system can save the content consumer's data, the relevant content creator's data, and transaction parameters for transactions made without user login, ensuring all relevant data is captured (Steps 105 and 108).

Automated Settlement and Data Storage: For automated settlement of transactions, the system leverages server systems, database systems, an event bus, short-lived memory cache, and a blockchain system to store financial data interoperably. The server system processes relevant data to be saved into a database and sent over an event bus for encryption and storage on the blockchain (Step 305). The blockchain writer system stores generated gesture financial data for future use, and a blockchain transaction stream scanner verifies transactions, determining if they should be stored in a database for further use (Steps 301 and 302). The event bus system publishes data in a public manner, accessible to any subscribed subsystem or third-party system (Step 703).

Example Implementation: In practice, users initiate a pledge by accessing a Social Network with the system installed (Step 101). The user performs a two-finger tap on the content in Step 102, triggering the pledge action if logged in (Step 103). If not logged in, the user is prompted to do so (Step 104), and upon login, the pledge is stored (Step 105). Non-logged-in users have their content creator's data and pledge parameters saved (Step 107), proceeding to further steps (Step 108).

In Step 301, the host application checks if the current date is after the set boundary for settling pledges (Step 302). Qualifying pledges are aggregated and sent to the server system (Step 303), which maps the data to payment details and processes the payment (Steps 304-305). Processed data is published to an event bus mechanism, updating the leaderboard database and recording data to the blockchain system (Steps 306-309). The blockchain scanner system filters transactions relevant to the invention and stores them in the database system (Steps 401-404).

By accessing the latest pledges, users can confirm or cancel them (Steps 601-610). Confirmed pledges are verified for available payment methods and updated accordingly, ensuring user control and reliability in financial transactions. This comprehensive system ensures seamless integration, transparency, and efficiency in managing online financial transactions across various digital platforms.

The system enables users to perform online financial transactions seamlessly through various gestures while consuming digital content on Technology Platforms or Social Networks. This approach allows users to initiate financial transactions directly from the same screen displaying digital content, ensuring an uninterrupted and seamless user experience. The system receives financial transaction requests initiated by a user gesture, processes information about the transaction amount and beneficiary, and confirms the transaction without interrupting the user's content consumption (Steps 102, 103, 104, 306). This integration significantly enhances user engagement by incorporating financial transactions smoothly into their content viewing experience.

Integration of Single Action Gestures: The system supports various types of single action gestures, including tapping on the screen, speaking a command, or shaking the device (Step 103). Specifically, a two-finger tap on the screen displaying content is recognized as a transaction gesture, with the first tap being ignored to avoid conflicts, and subsequent taps being counted as valid gestures (Steps 102, 104). This flexibility in gesture recognition ensures that the system can cater to different user preferences and device capabilities. Additionally, the system can interpret a series of consecutively occurring gestures as multiple transactions or a single consolidated transaction, depending on the context (Steps 301, 302). This interpretation allows for flexibility in how transactions are processed, enhancing the user experience.

Notification and Confirmation: After processing the transaction request, the system provides a visual or text confirmation on the screen, ensuring that the user is aware of the transaction without disrupting their content consumption (Step 306). This notification mechanism enhances user confidence and satisfaction by providing immediate feedback while maintaining an uninterrupted viewing experience.

Determination of Transaction Amount and Beneficiary: The system dynamically determines the transaction amount and beneficiary based on various factors, including the type of gesture, the content being viewed, and the profiles of the content consumer and creator (Steps 103, 304). For example, a single gesture can result in a pledge transaction of a predefined amount, such as $0.01, and a series of gestures can result in a proportionally higher transaction amount (Steps 301, 302). The system can also adjust transaction amounts based on user profiles, such as social media activity, geographical location, and interaction history with specific content creators (Steps 303, 304).

The system further refines the determination of transaction amounts and beneficiaries by analyzing the frequency and timing of gestures, the type of digital content, and past user activities (Steps 303, 304). By leveraging user profiles and historical data, the system ensures that transactions are personalized and relevant, enhancing the overall user experience. If the charity is not predefined by the content consumer or creator, the system uses a historical weighted average selection to determine the beneficiary, ensuring equitable distribution of funds (Steps 305, 306).

Consolidation and Settlement: The system supports the consolidation and settlement of transactions, particularly for pledge transactions. For instance, gestures made over a specified period can be consolidated and settled as a single donation at regular intervals, such as weekly or monthly (Steps 303, 304). These donations are managed by a Donor Advised Fund (DAF) Sponsor, which consolidates and distributes the donations to designated charities on a regular basis (Steps 305, 306). This structured approach ensures efficient management and distribution of funds, benefiting both users and charities. The system also ensures that the designated charities meet reasonable criteria, such as size and distribution capabilities (Step 306).

Automated Settlement and Blockchain Integration: For automated settlement, the system employs a combination of server systems, database systems, event buses, and blockchain technology (Steps 301-309). This infrastructure ensures secure, transparent, and efficient processing of financial transactions. The blockchain system records transactions, providing an immutable ledger that enhances trust and transparency among all participants (Step 308). The system also includes tools for users to access and verify their transaction history on the blockchain, further enhancing transparency and accountability (Steps 401-404).

Enhanced User Profile and Historical Data Utilization: The system leverages user profiles and historical data to refine transaction amounts and beneficiaries. This includes analyzing the frequency and timing of gestures, the type of digital content, and past user activities (Steps 303, 304). By doing so, the system ensures that transactions are personalized and relevant, enhancing the overall user experience. If the charity is not predefined by the content consumer or creator, the system uses a historical weighted average selection to determine the beneficiary, ensuring equitable distribution of funds (Steps 305, 306).

In practice, users initiate a pledge by accessing a Social Network with the system installed (Step 101). The user performs a two-finger tap on the content in Step 102, triggering the pledge action if logged in (Step 103). If not logged in, the user is prompted to do so (Step 104), and upon login, the pledge is stored (Step 105). Non-logged-in users have their content creator's data and pledge parameters saved (Step 107), proceeding to further steps (Step 108).

In Step 301, the host application checks if the current date is after the set boundary for settling pledges (Step 302). Qualifying pledges are aggregated and sent to the server system (Step 303), which maps the data to payment details and processes the payment (Steps 304-305). Processed data is published to an event bus mechanism, updating the leaderboard database and recording data to the blockchain system (Steps 306-309). The blockchain scanner system filters transactions relevant to the invention and stores them in the database system (Steps 401-404).

By accessing the latest pledges, users can confirm or cancel them (Steps 601-610). Confirmed pledges are verified for available payment methods and updated accordingly, ensuring user control and reliability in financial transactions. This comprehensive system ensures seamless integration, transparency, and efficiency in managing online financial transactions across various digital platforms.

This detailed process demonstrates the industrial applicability of the invention in providing an uninterrupted, efficient, and user-friendly financial transaction method that integrates seamlessly with digital content consumption. The system's ability to handle various transaction types, store transaction history, and automate settlement processes highlights its versatility and potential for wide adoption across different industries and digital platforms.

Determining Donor, Charity, and Donation Amount for Donor Advised Fund: The system effectively determines the donor, charity, and the amount for a Donor Advised Fund (DAF) by utilizing user gestures performed on the same screen displaying digital content on a Technology Platform or Social Network. When a user initiates a transaction request through a gesture (Step 102), the system receives detailed information about the amount the user, who is the donor, wishes to donate (Step 103). The system also gathers information about the transaction amount from the gesture and the beneficiary charity from the content being displayed (Steps 103, 104). By processing this financial transaction request, the system ensures a seamless and efficient transaction experience.

The user is notified of the transaction with a small disappearing notification on the screen, ensuring that their consumption of digital content remains uninterrupted (Step 306). This notification method maintains the user's engagement with the content while providing immediate feedback on the transaction. The system then allocates and distributes the donations to the specified charities, ensuring that the funds reach the intended beneficiaries (Step 305). Additionally, the system enhances user satisfaction by issuing donation tax receipts to users/donors, integrating the financial and administrative aspects of charitable giving within the user's social media experience (Step 308).

Access to Transaction History: The system provides users with comprehensive access to their financial transaction history, encompassing various details such as the identity of the Technology Platform or Social Network where the user viewed or consumed digital content, the specific digital content on which the transaction was initiated, and the identity of the content creator (Steps 402, 403). Users can review transactions over a designated period, viewing details like the monetary value of each transaction and the selected charities by both the content consumer and the content creator (Steps 403-404).

Transactions can be categorized into pledge transactions, donation transactions, or payment transactions (Step 402). The system allows users to cancel pledges made during a specified period, providing control over their financial commitments (Step 602). The involved parties are visually identified using their host application's primary identification method, ensuring clarity and accuracy in transaction records (Step 103). Furthermore, transaction histories can be shared across all host applications and published on a blockchain, ensuring transparency and immutability (Steps 703, 308).

The system includes means for aggregating and reporting transaction data, which encompasses total transactions, transaction settlements, pledge transaction distributions, and statistics related to content engagement (Step 304). This aggregated data offers valuable insights into user behavior and content interaction, assisting content creators and platform providers in optimizing their offerings. Additionally, the system facilitates the display of additional content or enables user interaction within the host application platform, enhancing the overall user experience (Step 401).

Device and Technology Platform Integration for Financial Transactions: The system integrates devices configured with antennas to communicate with Technology Platforms, processors to display digital content, memory to store transaction information, and displays to show transaction notifications. These notifications disappear without interfering with the user's content consumption, ensuring a seamless experience (Step 603). Devices can integrate with payment processors, allowing users to perform gestures that are then identified and stored by the device (Steps 104, 105, 106). The system utilizes touchscreen or touchpad technology to recognize specific gestures, and the visual boundaries of content are determined based on the content's dimensions and positioning within the user interface (Step 102).

Devices are capable of initiating and completing financial transactions autonomously, operating various applications, including social media platforms and browser applications (Step 104). The system employs authentication mechanisms such as social media profile data to identify logged-in users, and device information can be stored with transaction data as part of the identifier information (Steps 103, 304). This ensures that transaction records are comprehensive and reliable, even if the user does not log in during the transaction process. The system can also save the content consumer's data, the relevant content creator's data, and transaction parameters for transactions made without user login, ensuring all relevant data is captured (Steps 105, 108).

Automated Settlement and Data Storage: For automated settlement of transactions, the system leverages server systems, database systems, an event bus, short-lived memory cache, and blockchain technology (Steps 301-309). This infrastructure ensures secure, transparent, and efficient processing of financial transactions. The blockchain system records transactions, providing an immutable ledger that enhances trust and transparency among all participants (Step 308). The system also includes tools for users to access and verify their transaction history on the blockchain, further enhancing transparency and accountability (Steps 401-404).

In practice, users initiate a pledge by accessing a Social Network with the system installed (Step 101). The user performs a two-finger tap on the content in Step 102, triggering the pledge action if logged in (Step 103). If not logged in, the user is prompted to do so (Step 104), and upon login, the pledge is stored (Step 105). Non-logged-in users have their content creator's data and pledge parameters saved (Step 107), proceeding to further steps (Step 108).

In Step 301, the host application checks if the current date is after the set boundary for settling pledges (Step 302). Qualifying pledges are aggregated and sent to the server system (Step 303), which maps the data to payment details and processes the payment (Steps 304, 305). Processed data is published to an event bus mechanism, updating the leaderboard database and recording data to the blockchain system (Steps 306-309). The blockchain scanner system filters transactions relevant to the invention and stores them in the database system (Steps 401-404).

By accessing the latest pledges, users can confirm or cancel them (Steps 601-610). Confirmed pledges are verified for available payment methods and updated accordingly, ensuring user control and reliability in financial transactions. This comprehensive system ensures seamless integration, transparency, and efficiency in managing online financial transactions across various digital platforms.

This detailed process demonstrates the industrial applicability of the invention in providing an uninterrupted, efficient, and user-friendly financial transaction method that integrates seamlessly with digital content consumption. The system's ability to handle various transaction types, store transaction history, and automate settlement processes highlights its versatility and potential for wide adoption across different industries and digital platforms.

What is claimed is:

1. A method of performing an on-line financial transaction, comprising:
receiving a financial transaction request from a user, wherein such request is received from a Gesture on the same screen displaying digital content on Technology Platform or Social Network;
receiving information about the amount of the transaction from the Gesture or predefined by the method;
receiving information about the beneficiary from the user (content consumer) or content creator, content, Gesture, or predefined by the method;
utilizing predefined variables and/or predictive tools, including artificial intelligence, to determine all information required to complete the transactions, without any additional user prompt for information, selection or confirmation;
processing the financial transaction request based on the information; and
notifying the user of the transaction notification on the screen without interfering with the user's consumption of the digital content on the device.

2. The method of claim 1, wherein:
the Gesture triggers a transaction to complete without any additional user prompt for information, selection, or confirmation, so that the transaction completes without any interruption or pause
the Gesture is triggered while digital content is displayed on the screen and without interrupting user's access to content;
the Gesture triggers a payment to a single pre-determined charitable cause;
the amount of the Gesture initiated transaction is pre-determined, such as $0.01
a series of consecutively occurring single action Gestures may be interpreted as a series of transactions or a single transaction; and
the single Gesture action can be any single action Gesture, including tapping on screen or device, speaking of a sound (voice gesture), shaking of device, without limiting.

3. The method of claim 1, wherein:
the single action Gesture is a two finger tap on screen displaying content; and
the first single Gesture of two finger tap is ignored to avoid device conflicts, and all subsequent two finger taps are counted as single Gestures.

4. The method of claim 1, wherein:
the Gesture and related transaction is confirmed by displaying a visual or text confirmation or feedback to the user on top of the host interface;
the single action Gesture, the content, the content consumer, and content creator, pre-determined variables set by the method, and predictive tools, collectively determine the amount of the transaction;
the single action Gesture, the content, the content consumer, and content creator, pre-determined variables set by the method, and predictive tools, collectively determine the beneficiary of the transaction; and
the Gesture results in a transaction on the time and date of the Gesture.

5. The method of claim 1, wherein:
the Gestures from pledge transactions on the during certain time and date, are consolidated and settled with a donation on a periodic basis;
the donations are received by a charitable cause on a periodic basis, and such donations are consolidated and distributed to designated projects on regular intervals;
the user has option to reject or reverse a Gesture initiated transaction, only after the transaction completes; and
the user can cancel or reverse a Gesture initiated transactions prior to each periodic settlement.

6. The method of claim 1, wherein:
the transaction is a pledge transaction;
a pledge transaction is followed by a donation transaction; and
the financial transaction is one chosen from the group consisting of a donation transaction, any payment transaction, and any payment transaction in combination of a pledge transaction.

7. The method of claim 1, further comprising means for verifying the availability of funds or payment method associated with the user before settling transactions.

8. A system of performing an on-line financial transaction, comprising:
receiving a financial transaction request from a user, wherein such request is received from a Gesture on the same screen displaying digital content on Technology Platform or Social Network;
receiving information about the amount of the transaction from the Gesture or predefined by the system;
receiving information about the beneficiary from the user (content consumer) or content creator, content, Gesture or predefined by the system;
utilizing predefined variables and/or predictive tools, including artificial intelligence, to determine all information required to complete the transactions, without any additional user prompt for information, selection or confirmation;
processing the financial transaction request based on the information; and
notifying the user of the transaction notification on the screen without interfering with the user's consumption of the digital content on the device.

9. The system of claim 8, wherein:
the Gesture triggers a transaction to complete without any additional user prompt for information, selection, or confirmation, so that the transaction completes without any interruption or pause;
the Gesture is triggered while digital content is displayed on the screen and without interrupting user's access to content;
the Gesture triggers a payment to a single pre-determined charitable cause;
the amount of the Gesture initiated transaction is pre-determined, such as $0.01;
a series of consecutively occurring single action Gestures may be interpreted as a series of transactions or a single transaction; and
the single Gesture action can be any single action Gesture, including tapping on screen or device, speaking of a sound, shaking of device, without limiting.

10. The system of claim 8, wherein:
the single action Gesture is a two finger tap on screen displaying content; and
the first single Gesture of two finger tap is ignored to avoid device conflicts, and all subsequent two finger taps are counted as single Gestures.

11. The system of claim 8, wherein:
the Gesture and related transaction is confirmed by displaying a visual or text confirmation or feedback to the user on top of the host interface;
the Gesture, the content, the content consumer, and content creator, pre-determined variables set by the system, and predictive tools collectively determine the amount of the transaction;
the single action Gesture, the content, the content consumer, and content creator, pre-determined variables set by the system, and predictive tools collectively determine the beneficiary of the transaction; and
the Gesture results in a transaction on the time and date of the Gesture.

12. The system of claim 8, wherein:
the Gestures from pledge transactions on the during certain time and date, are consolidated and settled with a donation on a periodic basis;
the donations are received by a charitable cause on a periodic basis, and such donations are consolidated and distributed to designated projects on regular intervals;
the user has option to reject or reverse a Gesture initiated transaction, only after the transaction completes; and
the user can cancel or reverse a Gesture initiated transactions prior to each periodic settlement.

13. The system of claim 8, wherein:
the transaction is a pledge transaction;
a pledge transaction is followed by a donation transaction; and
the financial transaction is one chosen from the group consisting of a donation transaction, any payment transaction, and any payment transaction in combination of a pledge transaction.

14. The system of claim 8, further comprising means for verifying the availability of funds or payment method associated with the user before settling transactions.

15. A non-transitory computer readable medium having stored thereon machine-readable instructions executable to cause a machine to perform operations, comprising:
receiving a transaction request from a user, wherein such request is received from a Gesture on the same screen displaying digital content on Technology Platform or Social Network;
receiving information about the amount of the user;
receiving information about the amount of the transaction from the Gesture or predefined by the system and method;
receiving information about the beneficiary charity from the Gesture and the content displayed or predefined by the system and method;
utilizing predefined variables and/or predictive tools, including artificial intelligence, to determine and store all information required to complete the transactions, without any additional user prompt for information, selection or confirmation;
processing the financial transaction request based on the information;
notifying the user of the transaction with a small disappearing notification on the screen without interfering with the user's consumption of the digital content on the device;
Receiving the donations, allocating and distributing donations to charities; and
adding to the user satisfaction from engaging with social media platforms, through issuance of donation tax receipts to users/donors.

16. The non-transitory machine readable medium of claim 15, further comprising:
receiving and processing information regarding a Gesture, its frequency, time-separation between each Gesture;
receiving and processing information about the digital content on screen at an incident of Gesture;
historical activity of the user consuming the content;
Receiving unique or semi-unique identification information for the content consumer and creator;
receiving and processing user profile information about the content consumer and creator, predefined variables and/or predictive tools, including artificial intelligence;
wherein the single action Gesture, the content, the content consumer, and content creator, predefined variables and/or predictive tools, including artificial intelligence, collectively determine the amount of the transaction; and
the transaction can be pledge, donation or payment transaction, or combination thereof.

17. The non-transitory machine readable medium of claim 15, wherein at least one of the following from the group consisting of occurs:
the Gesture results in a pledge transaction in the amount of US$0.01;
the series of consecutively occurring Gestures results in a similar series of pledge transactions, each in the amount of US$0.01; and
the series of consecutively and closely occurring Gestures results in pledge transactions that are greater than US$0.01 or ratio greater than $0.01 per Gesture, e.g., geometrically increasing transaction amount as the number of consecutively occurring Gestures increases.

18. The non-transitory machine readable medium of claim 15, wherein:
the Gesture or series of Gestures results in different transaction amounts, based on the user's profile, social media profile, geographical location, device cost, and Gesture history, frequency of Gesture with a specific content creator vs another content creator, predictive tools, and predefined variables by system and method.

19. The non-transitory machine readable medium of claim 15, wherein,
the single action Gesture, the content, the content consumer, and content creator, predefined variables and/or predictive tools, including artificial intelligence, collectively determine the beneficiary of the transaction; and
the Gesture results in a pledge transaction to the benefit of a party selected by the content consumer or content creator, predefined variables set by the system and method, and/or predictive tools, including artificial intelligence.

20. The non-transitory machine readable medium of claim 15, wherein,
the Gesture triggers a transaction to complete without any additional user prompt for information, selection, or confirmation, so that the transaction completes without any interruption or pause;
the single action Gesture is triggered while digital content is displayed on the screen and without interrupting user's access to content;
the user has option to reject or reverse a Gesture initiated transaction, only after the transaction completes;
the user can cancel or reverse a Gesture initiated transactions prior to each periodic settlement;
the Gesture triggers a payment to a single pre-determined charitable cause; and
the amount of the Gesture initiated transaction is pre-determined, such as $0.01.
